(19) United States
(12) Patent Application Publication
(10) Pub. No.: US 2021/0022214 A1
(43) Pub. Date: Jan. 21, 2021

(54) BATTERY PACK

(71) Applicant: The Coleman Company, Inc., Wichita, KS (US)

(72) Inventors: Matthew G. Law, Wichita, KS (US); Ja'el Revona Bond, Wichita, KS (US); Erin Fillingham, Wichita, KS (US); Yiyun Culp, Wichita, KS (US); Adam A. Luedke, Kalamazoo, MI (US); Evan Fulford, Portage, MI (US)

(21) Appl. No.: 17/064,797

(22) Filed: Oct. 7, 2020

Related U.S. Application Data
(63) Continuation-in-part of application No. PCT/US2020/022898, filed on Mar. 16, 2020.
(60) Provisional application No. 62/911,579, filed on Oct. 7, 2019.
(60) Provisional application No. 62/942,471, filed on Dec. 2, 2019.
(60) Provisional application No. 62/818,851, filed on Mar. 15, 2019.

(51) Int. Cl. H05B 3/34; A47C 7/74; A47C 4/00; H01M 2/02; H01M 10/655

(52) U.S. Cl. CPC H05B 3/342; A47C 7/748; A47C 4/00; H05B 2203/029; H01M 10/655; H05B 2203/017; H01M 2/025

(57) ABSTRACT

A battery is provided comprising a power storage element, a battery housing, at least two electrical contacts, at least one first charging port, and at least one second charging port. The two electrical contacts and the first charging port are in electrical communication with the power storage element to allow discharge of the at least one power storage element. Similarly, the electrical contacts and the second charging port are in electrical communication with the power storage element to charge at least one power storage element.

### CROSS-REFERENCE TO RELATED APPLICATIONS

This application is a continuation-in-part to International Application No. PCT/US2020/022898, filed Mar. 16, 2020, titled BATTERY PACK, which claims priority to U.S. Provisional Patent Application No. 62/818,851, filed Mar. 15, 2019, titled BATTERY PACK, and also claims priority to U.S. Provisional Patent Application No. 62/911,579, filed Oct. 7, 2019, titled HEATED AND BUG PRODUCTS, and U.S. Provisional Patent Application No. 62/942,471, filed Dec. 2, 2019, titled MOVABLE HEATING PAD, the entirety of which is hereby incorporated by reference herein.

### FIELD OF THE INVENTION

The present invention relates to batteries. More particularly, the present invention relates to a battery pack that can be used interchangeably with a variety of devices.

### BACKGROUND OF THE INVENTION

Technology has become increasingly intertwined with our daily lives, where we use technology for both communication and comfort. However, in order to use those technological devices, those technological devices require a power source to function. While indoors, lights, air condition, and other technological devices are either already built into the building or can be plugged into a wall socket. However, it is generally not possible to simply plug in while outdoors due to the lack of a power source. While extension cords and batteries allow people to use their devices outdoors, they both have their disadvantages.

Extension cords may extend the area where the device may be used, but extension cords still require the device to be plugged into a wall socket thereby restricting where the user may use their devices. Batteries, on the other hand, allow the devices to be portable. However, disposable batteries create waste and do not produce sufficient power to run some devices. Other times, a rechargeable battery may only be compatible with one specific device. It is therefore desirable for a battery able to produce enough power to allow a variety of devices to run, as well as being compatible with several different devices.

Due to the heat and humidity, people often desire a method to cool themselves. Fans can generate a breeze which can help people feel cooler. Fans, however, are generally plugged into a wall socket, thereby restricting where they can be used. Other fans are small portable fans that use disposable batteries, and are only capable of generating a small breeze. It is therefore desirable for a fan to be portable and capable of generating a strong breeze. In addition to fans, flashlights, fluid pumps, and Bluetooth speakers all require power sources. Many must be plugged into a wall socket, or require disposable batteries or a specific rechargeable battery. Disposable batteries produce more waste, while proprietary rechargeable batteries can be inconvenient. It is therefore desirable for devices, such as fans flashlights, fluid pumps, and Bluetooth speakers to all be compatible with the same rechargeable battery.

Millions of people go camping every year, and “glamping” is becoming more popular with people who want to enjoy the comforts of home, while still being outdoors. People may want light and air conditioning while camping. Further, campers also often bring their technological devices (e.g., a cell phone), which may run out of power. Therefore, it is desirable for a tent that contains both lighting and cooling systems, and/or is able to charge technological devices.

Similarly, people also bring their technological devices, which can run out of power, while using shelters. In addition to the lack of charging stations in a typical shelter, there can be hundreds of tents set up at large events, making it difficult to identify an individual shelter at a distance. Therefore, it is desirable for a shelter to be able to charge technological devices and be readily identifiable from a distance.

### SUMMARY OF THE INVENTION

The present invention provides a battery that can be interchangeably used with a variety of technological devices. The battery includes a first battery section located and positioned at the first battery end, and a second battery section located and positioned at the second battery end. The first battery section includes a first battery section face, which as a first flap, a second flap, and a middle section. The first flap and second flap may each be selectively lifted to expose at least one USB-A port and/or USB-C port underneath. The USB ports may be used to charge technological devices that are connected to the USB port through a USB plug or to recharge the battery. The battery may include at least one indicator to signal the amount of power and/or if the battery is charging. The middle section may further include a light source, which may serve as a flashlight.

The second battery section includes at least one prong that allows the battery to selectively engage with a charging station to recharge the reusable battery. The charging station includes a central cavity for receiving the battery, where the battery can be inserted into the central cavity and engage the charging station. The battery may also be inserted into various technological devices to power those devices, allowing those devices to be used without a required specific battery. For example, the battery may be used with fans, lanterns, tents—including lighting a tent as well as cooling a tent, flashlights, Bluetooth speakers, fluid pump, and light source within a shelter.

### BRIEF DESCRIPTION OF THE DRAWINGS

FIG. 1 is a perspective view of an example embodiment of a battery;

FIG. 2 is a perspective view of the battery of FIG. 1, with certain elements removed to show elements thereunder;

FIG. 3 is a perspective view of the battery of FIG. 1 engaged with an example embodiment of a charging station;

FIG. 4 is a top plan view of the charging station and battery of FIG. 3;

FIG. 5 is a perspective view of an example embodiment of a fan;

FIG. 6 is a perspective view of an example embodiment of a lantern;

FIG. 7 is a perspective view of an example embodiment of a flashlight;

FIG. 8 is a perspective view of an example embodiment of a fluid pump;

FIG. 9 is an elevation view of the fluid pump of FIG. 8;

FIG. 10 is a perspective view of an example embodiment of a Bluetooth speaker engaged with a battery;

FIG. 11 is a perspective view of an example embodiment of a tent with a ground vent and a peak vent;

FIG. 12 is an enlarged perspective view of the ground vent embodiment of FIG. 11;

FIG. 13 perspective view of another example embodiment of a tent with a ground vent;

FIG. 14 is an enlarged perspective view of the peak vent embodiment of FIG. 11;

FIG. 15 is a perspective view of another example embodiment of a tent with a lighting system;

FIG. 16 is a perspective view of an interior portion of the tent of FIG. 15;

FIG. 17 is an elevation view of an example embodiment of a control panel in a tent;

FIG. 18 is an elevation view of an example embodiment of a storage pouch and a USB outlet;

FIG. 19 is a perspective view of an example embodiment of a shelter;

FIG. 20 is a perspective view of an example embodiment of control panel of for the shelter of FIG. 19;

FIG. 21 is a perspective view of an elongated battery receptacle constructed according to the teachings hereof;

FIG. 22 is a perspective view of an example embodiment of a heatable seat pad.

FIG. 23 is a perspective view of an example embodiment of a heatable stadium seat;

FIG. 24 is a perspective view of an example embodiment of a heatable, collapsible chair; and

FIG. 25 is a perspective view of an alternative example embodiment of a heatable, collapsible chair.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

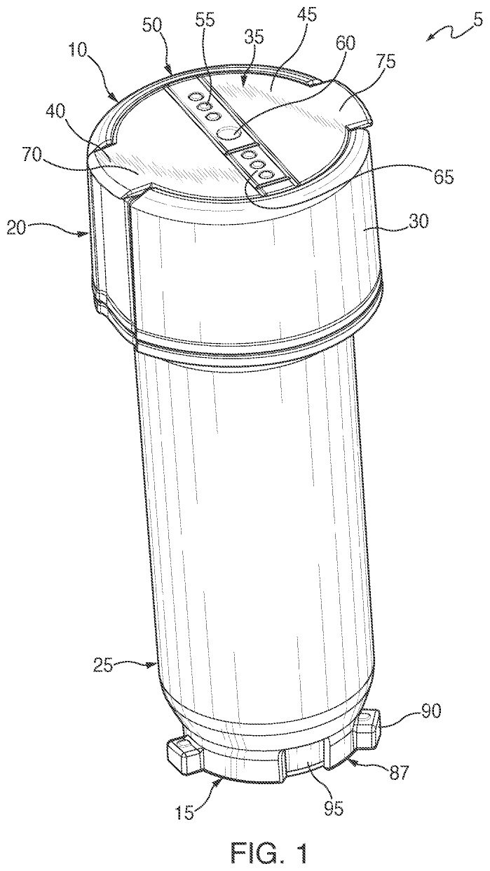

As illustrated in FIG. 1, a battery 5 includes a first battery end 10 and a second battery end 15. The battery 5 preferably includes a first battery section 20 and a second battery section 25. The first battery section 20 is preferably located and positioned at the first battery end 10. The second battery section 25 extends from the first battery section 20 to the second battery end 15. The first battery section 20 may have a larger width than the second battery section 25.

The first battery section 20 includes a first battery section sidewall 30 and a first battery section face 35. The first battery section sidewall 30 extends, from the second battery section 25 to the first battery section face 35. The first battery section face 35 is positioned at the first battery end 10, and may have a first flap 40, a second flap 45, and a middle section 50.

In one embodiment, the middle section 50 may be a narrow band that extends across the first battery section face 35, and is further located and positioned substantially along the diameter of the first battery section face 35. The middle section 50 may include at least one indicator 55, which may be embodied as an LED (light emitting diode). The at least one indicator 55 may signal to a user the amount of power remaining in power storage elements of the battery 5 and/or if the battery 5 is charging or is charging another device, as will be explained in more detail hereinafter. The power storage elements (not shown) may be lithium-ion storage elements or the like, as would be understood. The middle section 50 may further include a light source 60 that allows the battery 5 to be used as a flashlight. However, in other embodiments, the light source 60 may be located and positioned elsewhere on the battery 5.

The indicator(s) 55 and the light source 60 are in electronic communication with a printed circuit board (PCB) (not shown). The PCB may include resistors, controllers, and other electronic and data components that may be required to operate and/or control the battery 5. The PCB is also in electronic communication with a power source (not shown). The power source can provide power to the indicator 55, light source 60, and a device plugged into the battery 5, and the PCB may read when the indicator 55, light source 60, or device is being powered and/or when power should be provided to the indicator 55, light source 60, or device. A button 65 may also be provided for activating the light source 60.

Turning back to FIG. 1 and as stated previously, the first battery section 20 of the battery 5 includes the first flap 40 and the second flap 45, located and positioned on opposite sides of the middle section 50. The first flap 40 and the second flap 45 are each shown in FIG. 1 as semicircular in shape, mirroring one another on either side of the middle section 50. The first flap 40 includes a first tab 70 and the second flap 45 includes a second tab 75, which extend from the first flap 40 and second flap 45, respectively, opposite the middle section 50.

The first and second tabs 70, 75 are preferably located and positioned along the circumference of the first battery section face 35. The first and second tabs 70, 75 may be used to hingedly lift the first and second flaps 40, 45, respectively. Lifting the first and second flaps 40 and 45 exposes the area of the first battery section face 35 underneath the first and section flaps 40 and 45. In alternative embodiments, however, either or both of the flaps 40 and 45 may instead be removable from the battery 5.

In one embodiment, proximate the second battery end 15, the second battery section 25 includes a main charging and re-charging section 87. This section 87 may include at least one prong 90 for helping to selectively secure the battery 5 into a charging station or a product. Other securing structures are also envisioned. The section 85 further includes electrical contacts for receiving power from a charging station, or providing power to a product.

In yet another embodiment, the battery 5 may not include a main charging and recharging section 87 or at least one prong 90, but may instead only include the electrical contacts 95. The contacts 95 may be substantially similar to the at least one contact of the charging station 85. The contacts 95 may be located and positioned elsewhere on the battery 5, as appropriate.

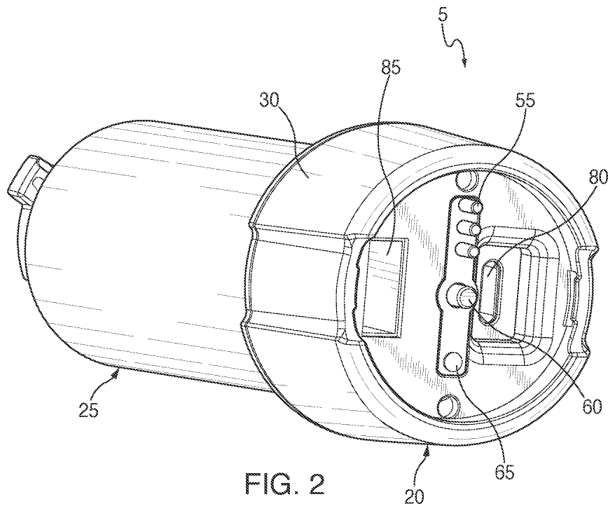

As can be seen in FIG. 2 in which the flaps 40 and 45 have been removed, the flaps 40 and 45 cover and protect a first charging port 85 and a second charging port 80. The first charging port 85 may be a Universal Serial Bus-A (USB) port 85, and the second charging port 80 may be a USB-C port 80. The first and second charging ports 80 and 85 will be referred to herein as USB-A port 85 and USB-C port 80 for ease of reference, although other types of charging ports are envisioned. A device may be connected to a USB cable (not shown), and the USB cable may then be plugged into the USB-A port 85. The device may thereby be powered via the USB-A port instead of the main charging and recharging section 87. Alternatively, a power source may be connected to a USB-C cord (not shown), and the USB-C cord may then be selectively plugged into the USB-C port 80, which allows the battery 5 to be charged therethrough, instead of via the electrical contacts 95. The battery 5 therefore is able to power various technological devices in multiple ways, as a battery or as a battery pack. The same is true for charging the battery 5. In alternative embodiments, the first battery section face 35 may have different types of USB ports.

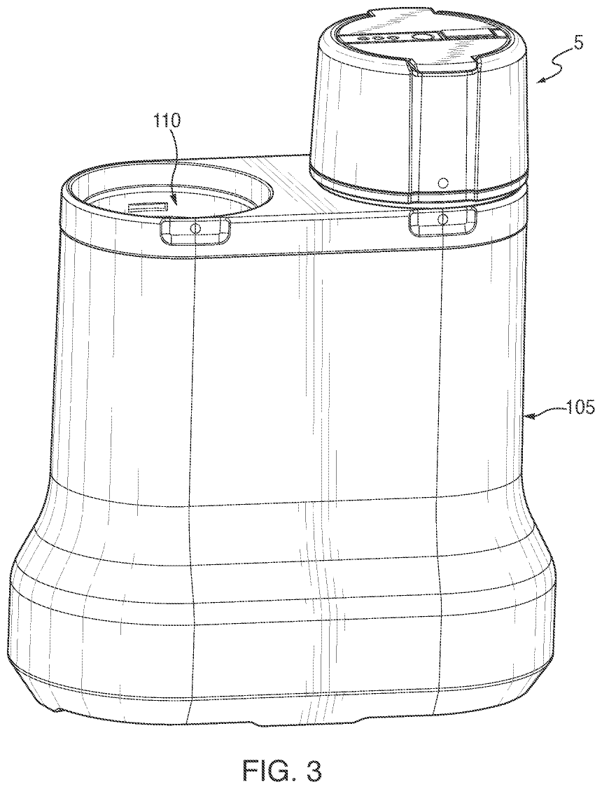

As illustrated in FIG. 3, the battery 5 may be inserted into a charging station 105. The charging station 105 preferably includes at least one cavity 110, each for receiving a battery 5. Each cavity 110 is therefore shaped and sized so a battery 5 can selectively engage and mate with the charging station 105. As shown in FIG. 3, the charging station 105 may include multiple cavities 110 so that more than one battery 5 may be charged at the same time.

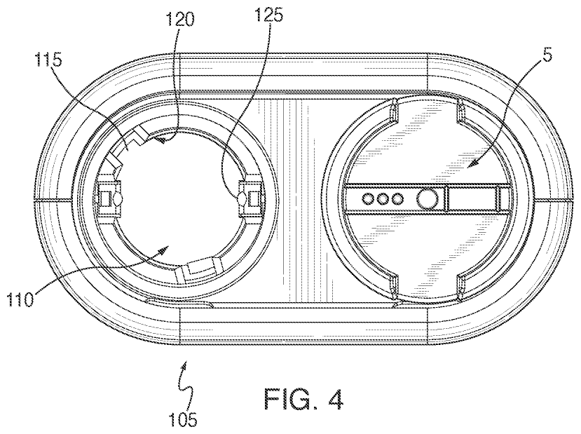

In the embodiment of FIG. 4, the cavity 110 may include at least one prong groove 115. The at least one prong groove 115 is shaped and sized so that the at least one prong 90 of the battery 5 may selectively engage with the at least one prong groove 115. Once received by a prong groove 115, the battery 5 may be twisted and the prong 90 may move within a track 120 in the charging station 120. Such rotation may also bring the contacts 95 of the battery 5 into engagement with corresponding electrical contacts 125 of the charging station 105. Once engaged and the charging station 105 is plugged into a wall socket, the battery 5 may be charged via contacts 95, 125 so that it can power other devices. FIGS. 3 and 4 illustrate a two-socket charger, with one socket empty. Other numbers of sockets may be provided for the charging station 105. Thus, a battery 5 may be charged via its electrical contacts 95, or via the USB-C port 80. The battery 5 may discharge through its electrical contacts 95, or through the USB-A port 85. It therefore can act as a rechargeable battery or as an external battery pack. It may also be daisy-chained with other batteries 5, by connecting the USB-A port 85 on one battery 5 to the USB-C port 80 on another battery 5. This can be done with as many batteries 5 in series as desired.

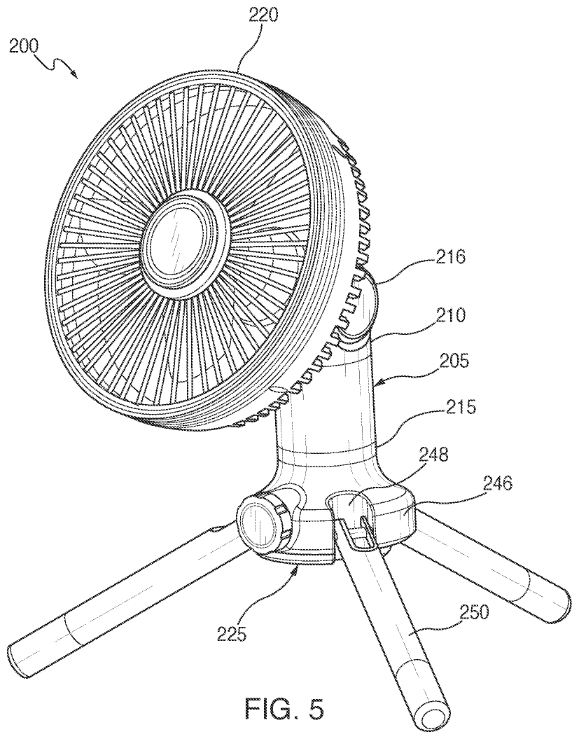

As seen in FIG. 5, a fan 200 includes a fan mount 205 with a first fan mount end 210 and a second fan mount end 215. The fan mount 205 as shown has a circular cross section, but may have other cross sectional shapes in alternative embodiments. The fan mount 205 is adjacent to and abuts a fan hinge 216 at the first fan mount end 210. The fan hinge 216 preferably allows the fan 200 to rotate. The fan hinge 216 is adjacent to and abuts a protective guard 220. The protective guard 220 is preferably a cage-like structure that surrounds standard fan components, such as a motor and blades.

The second fan mount end 215 of the fan mount 205 includes a fan central cavity 225. The fan central cavity 225 is preferably a cavity at the second fan mount end 215 that extends into the fan mount 205 and towards the first fan mount end 210. The fan central cavity 225 is shaped and sized so that a battery 5 may be inserted within. The fan central cavity 225 is preferably substantially similar to the cavity 110 of the charging station 105. Therefore, depending on the embodiment of the battery 5, the fan central cavity 240 may include at least one fan prong groove (not shown), substantially similar to the prong groove 115 of the cavity 110, as well as corresponding electrical contacts for receiving power from the battery 5.

In addition to, or concurrently with providing power to the fan 200, the battery 5 may also charge or power another device through its USB-A port 85, or receive additional power via its USB-C port 80. The battery 5 can also be removed so that the battery 5 may be recharged or may be removed so that the battery 5 may be used with another device.

The second fan mount end 215 of the fan mount 205 is preferably adjacent to and abuts a fan leg connector section 246. In one embodiment, the fan leg connector section 246 engages the fan mount 205. The fan leg connector section 246 further includes at least one fan leg groove 248. The fan leg groove 248 may be a U-like groove shaped and sized so that at least one fan leg 250 may fit within the fan leg groove 248.

The at least one fan leg 250 projects away from the fan mount 205. The at least one fan leg 250 is preferably pivotally connected to the fan leg connector section 246. The shape of the fan leg groove 248 and the pivoting engagement preferably allows the fan leg 250 to bend or fold. The at least one fan leg 250 may fold upwards so that when the fan legs 250 are folded, the fan legs 250 are adjacent to the fan mount 205. The fan 200 may therefore be folded so that the fan 200 is more portable. The second fan mount end 215 of the fan mount 205 may further include a fan ring which allows the fan 200 to be hung upside down from a surface, such as a ceiling, roof, or other structure.

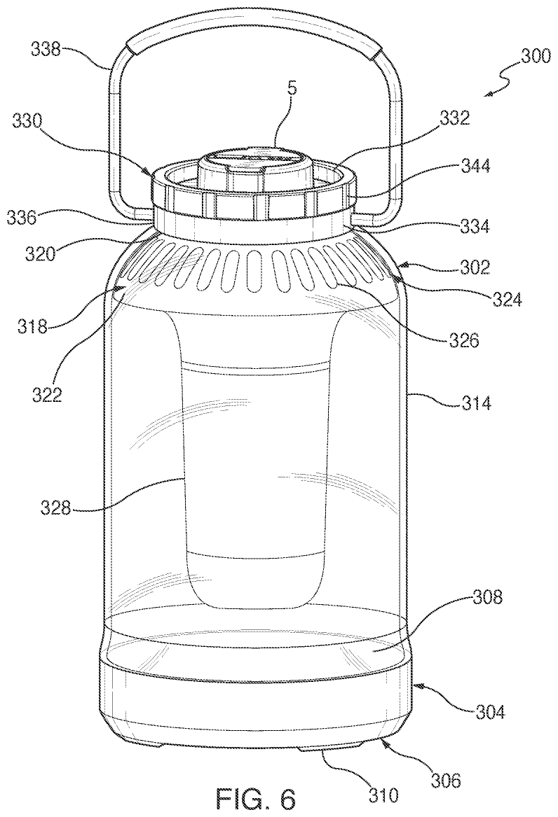

As seen in FIG. 6, the battery 5 may also be inserted into a first embodiment of a lantern 300, as will be explained in more detail hereinafter. The first embodiment of the lantern 300 may include a first lantern end 302 and a second lantern end 304, with a lantern base 306 located and positioned at the second lantern end 304. The base 306 may include a first base face 308 and a second base face 310. The second base face 310 is adjacent to and abuts a surface (e.g. table, ground, or ledge) when the lantern 300 is placed on the surface. A globe 314 extends from the first base face 308. The globe 314 is preferably transparent or translucent.

A heat sink 318 has a first heat sink end 320 and a second heat sink end 322. The heat sink 318 may include a slotted portion 324 preferably located and positioned above the globe 314. The slotted portion 324 preferably includes at least one slot 326 for air flow purposes. The heat sink 318 is adjacent to and abuts a light source 328. The light source 328 is located and positioned within the globe 314, and extends downwardly from the heat sink 318. Thus, the light source 328 is suspended from the top of the lantern 300.

A top portion 330 of the lantern 300 preferably has a top face 332 and a top sidewall 334 circumscribing the top face 332. The top portion 330 may extend from the heat sink 318. The top portion 330 preferably includes at least two top portion apertures 336 that extend through the top sidewall 334. A pair of top portion apertures 336 are preferably located and positioned on opposite sides of the top sidewall 334. The top portion apertures 336 are shaped and sized so that a handle 338 may extend into and through the top portion apertures 336. In one embodiment, the top portion 330 has two top portion apertures 336 and a curved half circle shaped handle 338, which includes a hook (not shown) at both ends of the handle 338, may be inserted into the top portion apertures 336 and used to secure the handle 338 to the top portion 330. The top portion 330 further includes a top portion aperture (shown with a battery 5 installed therein). The top portion aperture is preferably located and positioned in the center of the top portion 330 and also extends through the top portion 330. The top portion aperture may have the same structure as any other battery receptacle discussed herein.

Once the battery 5 has been selectively inserted into the lantern central cavity, the battery 5 may act as a power source and provide power to the first embodiment of the lantern 300. The lantern 300 may further include a dial or control switch 344. In one embodiment, the control switch 344 is located and positioned on the top portion 330 of the lantern 300. The control switch 344 may turn the light source 328 on or off, as well as controlling the brightness of the light source 328.

Other lantern-style embodiments are also envisioned. For example, lanterns in which the battery 5 is inserted from below, with corresponding light sources extending up from the bottom, rather than down from the top. may be used.

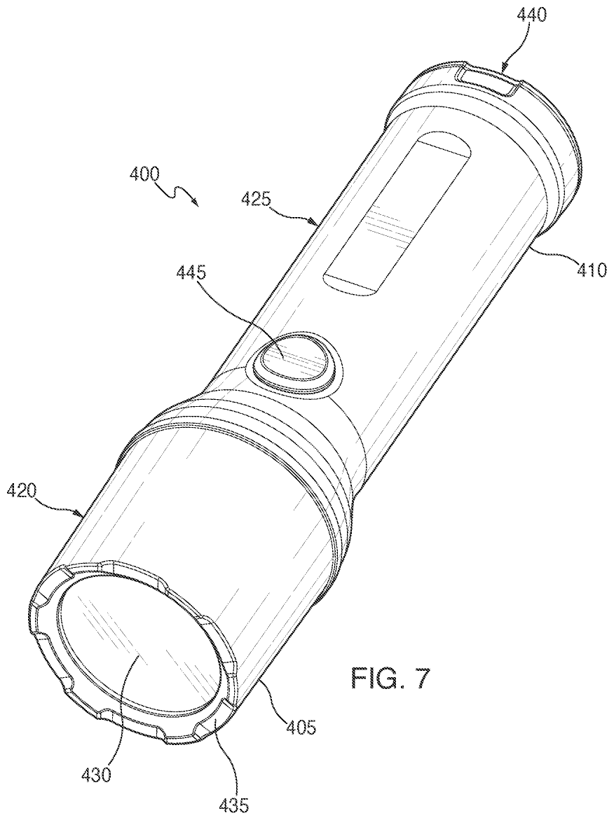

In addition to the fan 200 and various embodiments of the lantern 300, the battery 5 may further be compatible with a flashlight 400, shown in FIG. 7. The flashlight 400 may have a first flashlight end 405 and a second flashlight end 410. The flashlight 400 further includes a flashlight housing 415 that has a first flashlight housing section 420 and a second flashlight housing section 425. The first flashlight housing section 420 is located at the first flashlight end 405, while the second flashlight housing section 425 is located at the second flashlight end 410. The first flashlight housing section 420 is preferably a cylindrical member, as is the second flashlight housing section 425. The first flashlight housing section 420 may have a larger circumference than the second flashlight housing section 425. The first flashlight housing section 420 includes an LED or bulb (not shown) which is the light source for the flashlight 400, and a reflector (not shown) that is preferably a funnel-like shape surrounding the LED to form a focused beam of light. The reflector may be made out of an aluminum-coated plastic. The first flashlight housing section 420 further includes a lens 430 that extends over the first flashlight end 405 to prevent the LED from breaking. A bezel 435, which may be an annular ring, may be placed over the lens 430 to secure the lens 430 to the flashlight 400.

The second flashlight housing section 425 includes a flashlight battery cavity 440 located and positioned at the second flashlight end 410 and extends towards the first flashlight end 405. The flashlight cavity 446 is shaped and sized so that the battery 5 may be inserted into the flashlight cavity 440 so that the flashlight 400 may selectively engage with the battery 5. The battery cavity 440 of the flashlight 400, and all other such cavities discussed herein, may have the same structure as any other battery receptacle discussed herein.

When the battery 5 is inserted into the flashlight cavity 440 and selectively engages with the flashlight 400, a switch 445 may be actuated thereby completing the electrical connection causing the flashlight 400 to turn on. In one embodiment, the switch 445 may have a low light setting and a high light setting. The second flashlight end 410 may further include a loop aperture where a string may be inserted into and through to make a loop so that a user may insert their hand through the loop to reduce the possibility of dropping the flashlight 400.

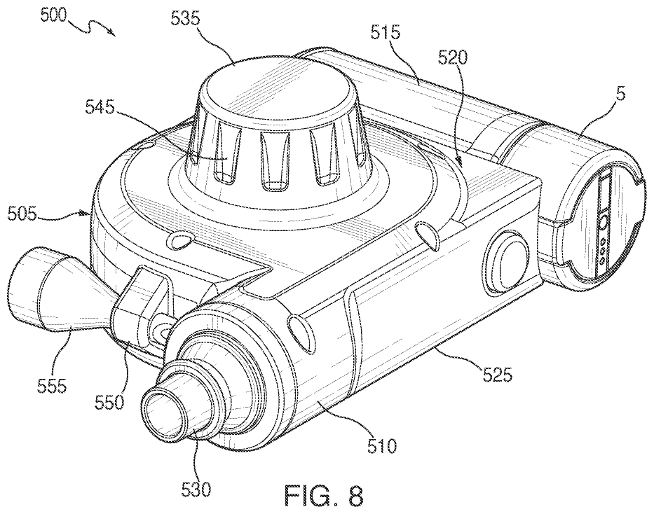

Turning to FIG. 8, the battery 5 may further be compatible with a fluid pump 500. The fluid pump 500 includes a housing 505 that surrounds the components of the fluid pump 500. The housing 505 preferably has a first housing end 510 and a second housing end 515, as well as a first housing face 520 and a second housing face 525. In one embodiment, the housing 505 may be generally circular with a nozzle 530 located and positioned at the first housing end 510. The nozzle 530 may be inserted into an aperture of an object that the fluid pump 500 is being used to fill with fluid.

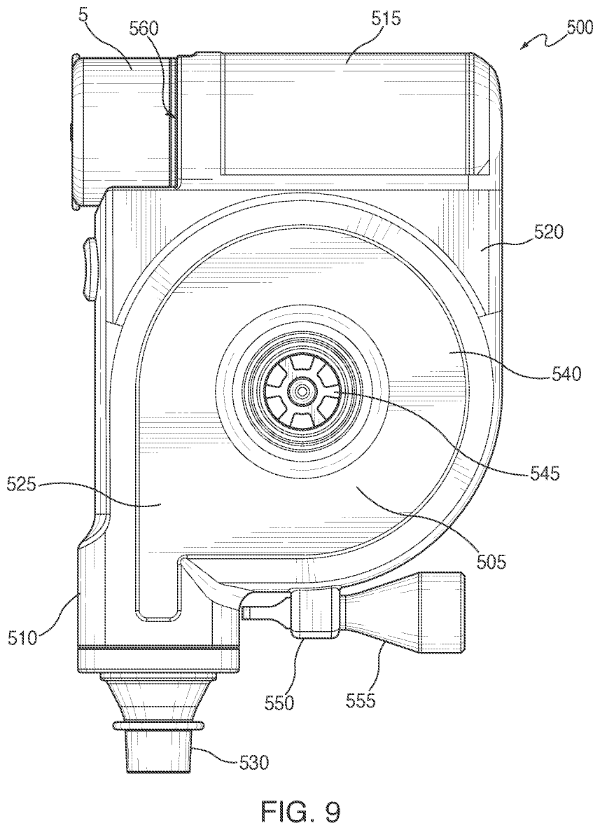

The housing 505 further includes a first protrusion 535 that projects away from the first housing face 520, and a second protrusion 540 that projects away from the second housing face 525, illustrated in FIGS. 8 and 9. Both the first protrusion 535 and the second protrusion 540 may be circular projections. In one embodiment, the second protrusion 540 may have a larger circumference than the first protrusion 535. The first protrusion 535 includes at least one pump aperture 545 that allows for fluid intake through protrusion 535. At the first housing end 510, the housing 505 may also include a receiver 550 shaped and sized so that an accessory nozzle 555 may be secured within the indention 550. The accessory nozzle 555 may selectively engage the nozzle 530 when it is inserted onto the nozzle 530. When the accessory nozzle 555 is placed onto the nozzle 530, the accessory nozzle 555 allows the nozzle 530 to be inserted into a smaller aperture of an object, where the fluid pump 500 is being used to fill the object with the fluid, than what otherwise might not be possible.

The housing 505 also includes a pump cavity 560, (shown with a battery 5 installed therein), located and positioned at the second housing end 515 and extends towards the first housing end 510. Once the battery 5 has been inserted into the pump cavity 560, the battery 5 may provide power to standard components of a fluid pump, such as a motor and impeller. The fluid pump 500 may therefore take in fluid through the first protrusion 535 and/or the second protrusion 540 and pump out the fluid through the nozzle 530. The battery 5 is therefore compatible with several different devices, including the fluid pump 500.

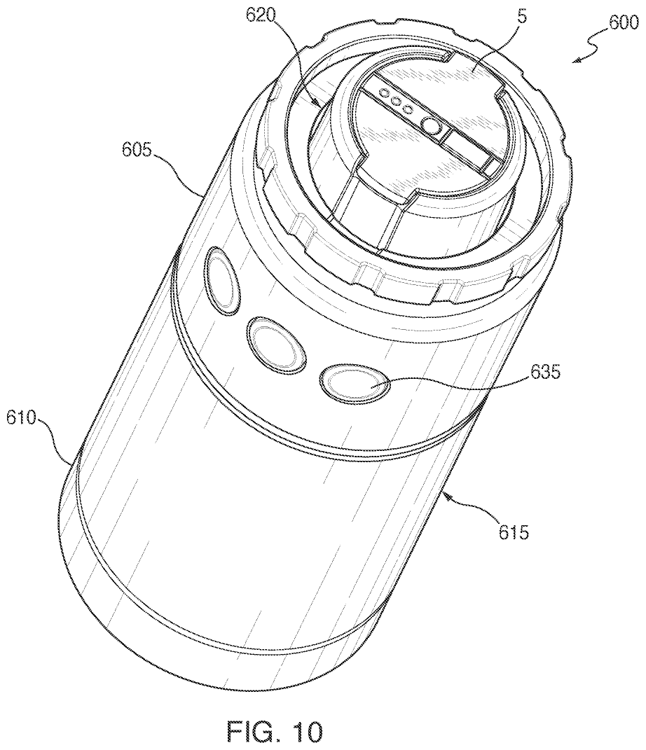

In addition to the fluid pump 500, the battery 5 may further be compatible with a speaker 600, shown in FIG. 10. The speaker 600 includes a first speaker end 605 and a second speaker end 610. The speaker 600 further includes a housing 615, which may have a circular cross section. In alternative embodiments, the housing 615 may be other cross sectional shapes. The housing 615 includes a speaker cavity 620 that extends from the first speaker end 605 towards the second speaker end 610. The speaker cavity 620 is shaped and sized so that the battery 5 may be inserted into the speaker cavity 620. When the battery 5 selectively engages with the speaker 600, the battery 5 provides power to standard components of the speaker 600. For example, the housing 615 may further include various components such as an amplifier, drivers, and input. For example, the input may be a Bluetooth module. These components are all preferably located and positioned within the housing 615, surrounding the speaker cavity 620. The speaker may further include buttons 635 that may turn the speaker 600 on and off, as well as controlling the volume, and music, generally. The speaker 600 is powered by the battery 5, which is also interchangeable or compatible between other technological devices.

The battery 5 may also be compatible with a tent 700, as will be described in more detail hereinafter. The tent 700 includes at least two tent poles 702, and tent walls 704, illustrated in FIG. 11. In one embodiment, the tent poles 702 are preferably cylindrical members, and may be hollow to reduce their weight. The at least two tent poles 702 may further be rigid or bendable. In embodiments when the at least one tent pole 702 is bendable, the tent poles 702 may be linked together through elastic cords extending through the hollow center of the at least two tent poles 702. The tent poles 702 may be inserted into the at least one angled joint fitting 703 to connect the tent poles 702 to one another, forming the structure of the tent 700.

The tent 700 may further include a ground sheet (not shown) that is located and positioned adjacent to and abuts the ground when the tent 700 has been set up. The tent 700 further includes at least three tent walls 704, where each tent wall 704 extends between the at least two tent poles 702 to create a barrier or wall. Each tent wall 704 is preferably adjacent to at least two other tent walls 704 and the ground sheet (not shown). The tent 700 therefore has a ground sheet (not shown) and at least three tent walls 704 that project upwards and away from the ground sheet. The at least three tent walls 704 preferably meet to form a peak 706. Both the ground sheet and tent walls 704 are preferably waterproof. Other tent structures are also envisioned, as would be understood.

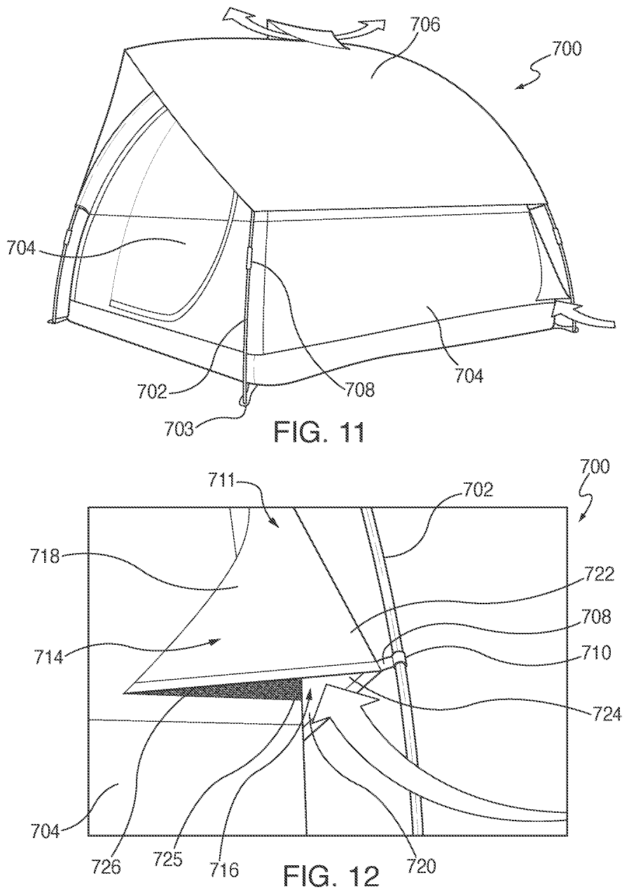

In one embodiment shown in FIG. 12, the ground sheet and the tent walls 704 may each include at least one tent loop 708, which is an extra piece of material that creates a loop or aperture shaped and sized so that a tent pole 702 may be inserted into and through the tent loop 708. In other embodiments, the tent loop 708 may engage a tent hook 710, which may be hooked onto the tent poles 702. In yet another embodiment, the tent hook 710 may be attached directly to the tent wall 704, also allowing the tent wall 704 to engage with the tent pole 702. The ground sheet and tent walls 704 are therefore able to selectively engage the tent poles 702 so that the ground sheet and tent walls 704 may be stretched or held between the tent poles 702 to form the structure of the tent 700.

The tent 700 may further include at least one ground vent 711. In one embodiment, the at least one ground vent 711 may be located and positioned at a corner or junction of adjacent tent walls 704. In other words, the at least one ground vent 711 may be located where two adjacent tent walls 704 abut one another. In one embodiment, the at least one ground vent 711 is preferably located closer to the ground sheet rather than the peak 706 of the tent 700. The ground vent 711 includes a first ground vent flap 714 and a second ground vent flap 716. A first side 718 and 720 of the first ground vent flap 714 and the second ground vent flap 716, respectively, are adjacent to and abut the tent wall 704. A second side 722 and 724 of the first ground vent flap 714 and the second ground vent flap 716, respectively, are adjacent to and abut each other. The first ground vent flap 714 and second ground vent flap 716 are preferably angled, creating an upside V-like shape. The ground vent 711 therefore has an opening 725, closer to the ground, which extends into the ground vent 711.

The second sides 722 and 724 of the first ground vent flap 714 and the second ground vent flap 716 preferably includes a tent hook 710 or tent loop 708 allowing the ground vent 711 to engage the tent pole 702. When the ground vent 711 has been attached to the tent pole 702, the ground vent 711 is preferably pulled towards the tent pole 702 so that the ground vent 711 is a triangular pyramid-like shape. The ground vent 711 further includes a mesh area 726 located and positioned in the area underneath the first ground vent flap 714 and the second ground vent flap 716 when the ground vent 711 is selectively engaged to the tent pole 702. The mesh area 726 is preferably part of the tent wall 704, and is a mesh-like material capable of allowing air circulation. The at least one ground vent 711 allows air to flow into the tent 700. The ground vent 711 and its opening 725 are preferably angled and located so that air may flow upwards into the tent 700.

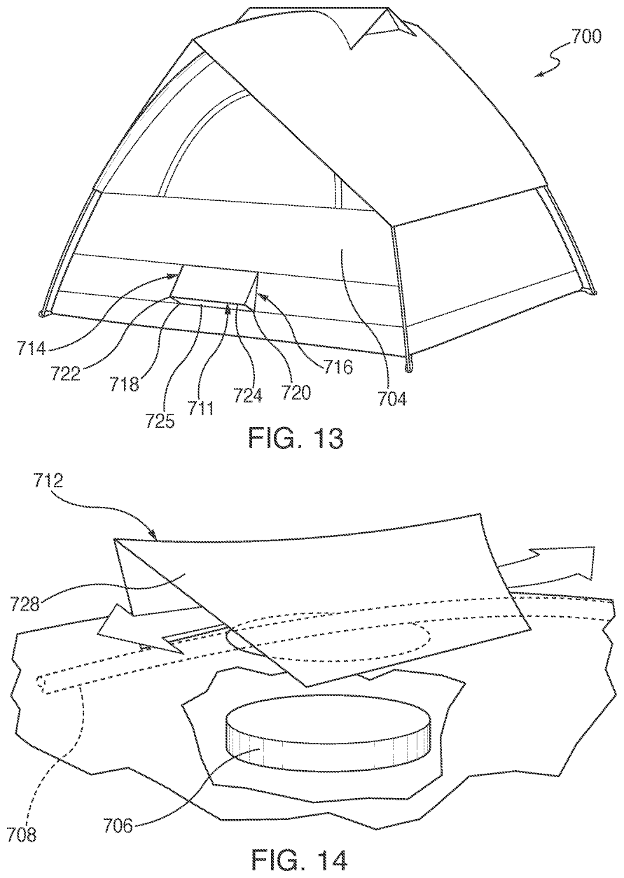

In another embodiment and as shown in FIG. 13, the ground vent 711 may be located and positioned on a tent wall 704, instead of at a corner or intersection of two tent walls 704. The ground vent 711 may include the first ground vent flap 714, the second ground vent flap 716, and a ground vent top 727. The first and second ground vent flaps 714 and 716 may be triangle-like shapes, while the ground vent top 727 may be a rectangular-like shape. The first side 718 of the first ground vent flap 714 and the first side 720 of the second ground vent flap 716 are both adjacent to and abut the tent wall 704. The second sides 722 and 724 of the first ground vent flap 714 and the second ground vent flap 716, respectively, are adjacent to and abut the ground vent top 727. The ground vent top 727 extends between the first and second ground vent flaps 714 and 716. The ground vent 711 may be positioned in an extended position, away from the tent wall 704, through tent poles 702. The first ground vent flap 714, the second ground vent flap 716, and the ground vent top 727 preferably create a triangle-like shape that projects away from the tent wall 704. The ground vent 711 therefore has an opening 725, closer to the ground. The ground vent 711 also preferably has a mesh area 726 as part of the tent wall 704, at the area underneath the ground vent 711. The mesh area 726 may allow air circulation into the interior portion of the tent 700.

The tent 800 may also include a peak vent 712, shown in FIG. 14. While the peak vent 712 may also allow air to flow into the tent, the peak vent 712 preferably allows air to travel out of the tent as the air currents rise in hot weather. The peak vent 712 preferably has at least two peak sides 728. The peak vent 712 preferably has as many peak sides 728 as there are tent walls 704, but may have a different number of peak sides 728 in other embodiments. The peak vent 712, and its peak sides 728, may therefore extend along the peak 706. In another embodiment, the peak vent 712 may include two peak sides 728 that engages and extends or project away from the tent walls 704 or tent loops 708. The peak sides 728 may be attached to the tent walls 704 or tent loops 708, while two tent peak poles 730 preferably engages the peak vent 712 substantially in the center of the peak 706, on both sides of the peak 706. The peak vent 712 therefore forms a triangular shape over the peak 706 of the tent 700. Other structures for the peak vent are also envisioned.

Similarly to the first and second ground vent flaps 714 and 716, the peak sides 728 are preferably made out of the same material as the tent walls 704. However, in alternative embodiments, the peak sides 728 may be made out of a different material or materials. The area underneath the peak vent 712 is preferably made out of a mesh-like material, therefore allowing air to pass through the peak 706. The tent 700 may therefore be cooler due to the ground vents 711 and peak vent 712 because the cool air can enter the tent 700 through the ground vent 711 and warm air can exit through the peak vent 712.

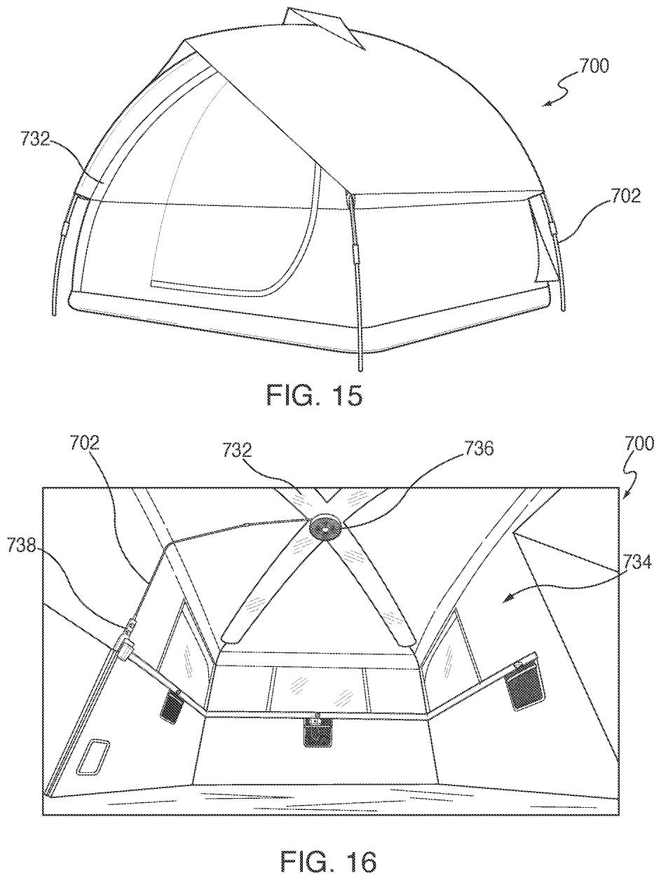

In addition to the ground vents 711 and peak vent 712, the tent 700 may include at least one light source 732, as shown in FIGS. 15 and 16. The at least one light source 732 may be located and positioned along the at least one tent pole 702. The at least one light source 732 may be further located and positioned in an interior portion 734 and/or exterior portion (not shown) of the tent 700. The light source 732 may therefore provide light inside of the tent 700 so that people can see while inside the tent 700, and/or provide light outside of the tent so that people can better see the tent 700 from a distance or can see while near the tent 700 due to the light source 732. The tent 700 may further include a tent fan 736 in an interior portion 734 of the tent 700, preferably near the peak 706. The tent fan 736 may provide air flow to cool the interior portion 734 of the tent 700.

Both the light source 732 and the tent fan 736 may be controlled by a control panel 738, illustrated in FIG. 16. The control panel 738 is therefore mechanically and electronically connected to either or both of the light source 732 and the tent fan 736. The control panel 738 may include dials, switches, and/or buttons. The dials, switches, and/or buttons may turn the light source 732 and the tent fan 736 on or off, as well as preferably controlling the brightness of the light source 732 and the strength of the wind generated by the tent fan 736. The control panel 738 may also control the direction of the wind generated by the tent fan 736, as well as the speed of the rotation of the tent fan 736 blades.

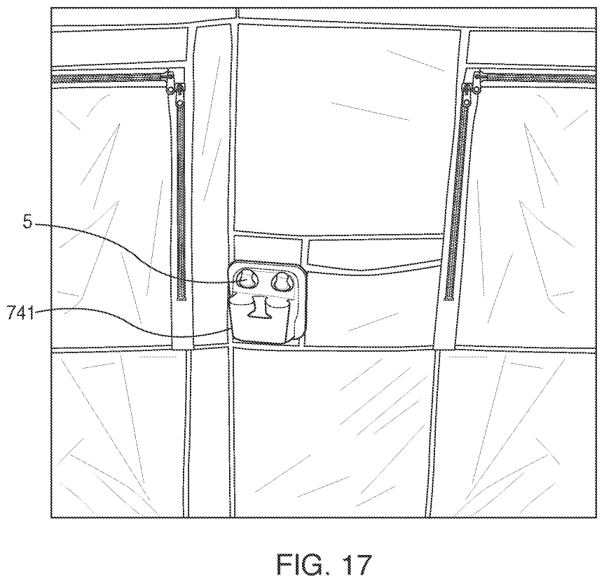

The control panel 738, and therefore the light source 732 and tent fan 736, may be powered the at least one battery 5. The control panel 738 may include one or more battery cavities for receiving one or more batteries, as discussed above. The control panel 738 may be located and positioned on a tent pole 702, in the interior portion 734 of the tent 700. In yet another embodiment, additionally or alternatively, there could at least one additional battery 5 located within a power pack 741, as seen in FIG. 17. The power pack 741 may include at least one cavity for receiving a battery 5, as discussed above. The batteries 5 within the power pack 741 are electronically and mechanically to the light source 732, tent fan 736, and/or the USB ports 752 to provide power to same. Separate controls for each may also be provided, as would be understood.

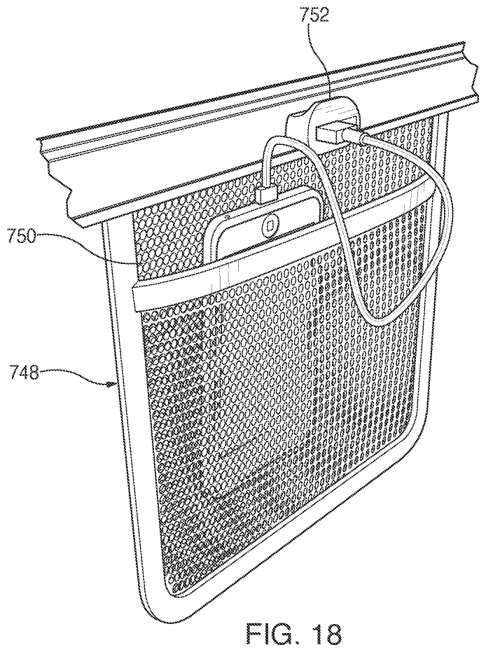

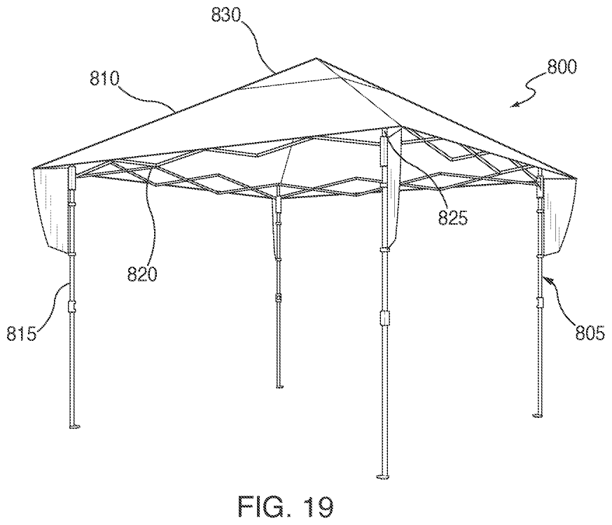

Turning to FIG. 18, the tent 700 may further include at least one storage pouch 748 located and positioned on the tent walls 704. The storage pouches 748 may include a storage pouch opening 750 allowing items to be placed within the storage pouch 748. The tent 700 may also include at least one USB port 752 that may be used to charge electronic devices. The USB port 752 is preferably in electronic and mechanical connection with at least one battery 5. The USB port 752 may be located and positioned above a storage pouch 748 so that the electronic device may be placed within the storage pouch 748 as it is charging. The battery 5 may therefore be the power source for the light source 732, the tent fan 736, and any electronic devices that are plugged into the USB port to be charged.

The battery 5 is preferably further compatible with a shelter 800, shown in FIG. 19. The shelter 800 includes a frame assembly 805 and a canopy 810. The frame assembly 805 includes at least three leg members 815, a truss assembly 820, and a roof assembly 825. When the shelter 800 has been assembled, the leg members 815 are adjacent to and abut the ground. The leg members 815 extend upwards, and the truss assembly 820 extends between the leg members 815. The truss assembly 820 preferably allows for scissor-like folding for deployment and collapsing of the frame. The roof assembly 825 preferably also allows for expansion and collapsing.

Once the shelter 800 has been assembled, the roof assembly 825 supports the canopy 810. The canopy 810 preferably extends over the frame and creates a pyramid-like shape. In one embodiment, the canopy 810 has a skylight 830 preferably located and positioned at the peak of the canopy 810. The canopy 810 is preferably made out of an opaque material, while the skylight 830 is preferably made out of a transparent or translucent material. The skylight 830 may include a shelter light source (not shown) or the shelter light source may be located and positioned underneath the skylight 830. In one embodiment, the light source 835 may be RGB light emitting diodes. The light source 835 may therefore shine through the skylight 830 preferably providing light within the shelter 800, and also allowing people to see and find the shelter 800 from a distance. In another embodiment, the light source 835 may extend throughout the entire canopy 810, so that the entire canopy 810 can be lit instead of just the skylight 830. The light source 835 may also be different colors (e.g., red, blue, green, purple).

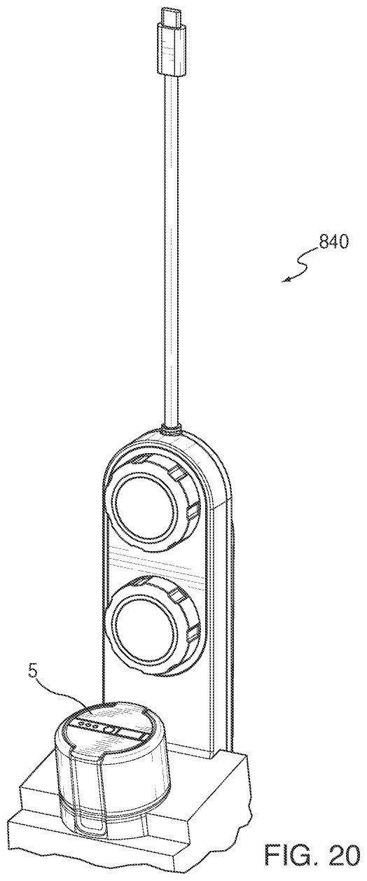

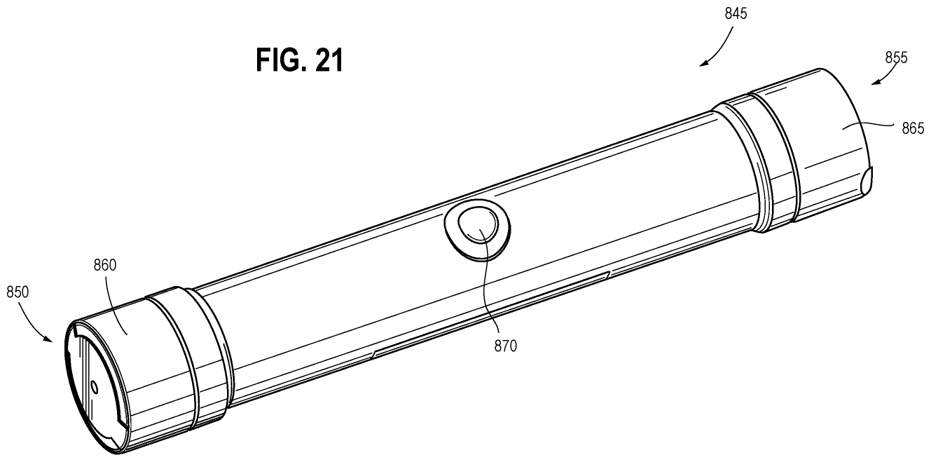

The light source may be controlled by a shelter control panel 840, as seen in FIG. 20. The shelter control panel 840 may include a variety of switches, dials, and/or buttons. The shelter control panel 840 may be in mechanical and electrical communication with the light source 840. The shelter control panel 840 can turn the light source on and off, as well as preferably control the brightness and color of the light source 835. The shelter control panel 840 also includes a cavity which is shaped and sized so that a battery 5 may be inserted within the shelter control cavity. As such, the shelter control panel 840 may act as a power station for the shelter 800. The battery 5 is therefore the power source for the light source 840. The battery 5 may also be compatible with a variety of technological devices.

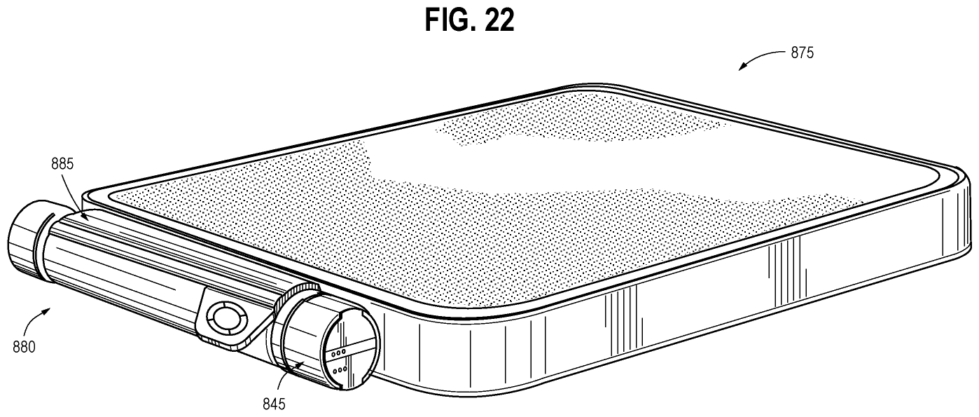

Turning to FIG. 21, an elongated battery receptacle 845 is illustrated that may be used to secure two batteries such as the battery 5 therein. The receptacle 845, when provided with batteries, may power the various devices set forth above and those set forth below. As illustrated, the receptacle 845 is elongated so that it can house two (or more) batteries such as the battery 5 that are positioned end to end relative to one another. By being able to house more than one battery 5, the receptacle 845 may be used with accessories that demand increased power. Notwithstanding the foregoing, the devices described below may be operable by one battery 5 and thus receptacles designed to house one battery 5 may also be used to power the devices described below. The receptacle 845 preferably includes each of a first end 850 and a second end 855 provided with an end cap 860 and 865, respectively. The end caps 860, 865 are preferably independently removable so that a user may access batteries contained therein from either end 860, 865. A button member 870 is preferably provided that allows a user to activate the batteries contained within the receptacle to power any of the technological devices set forth above or below.

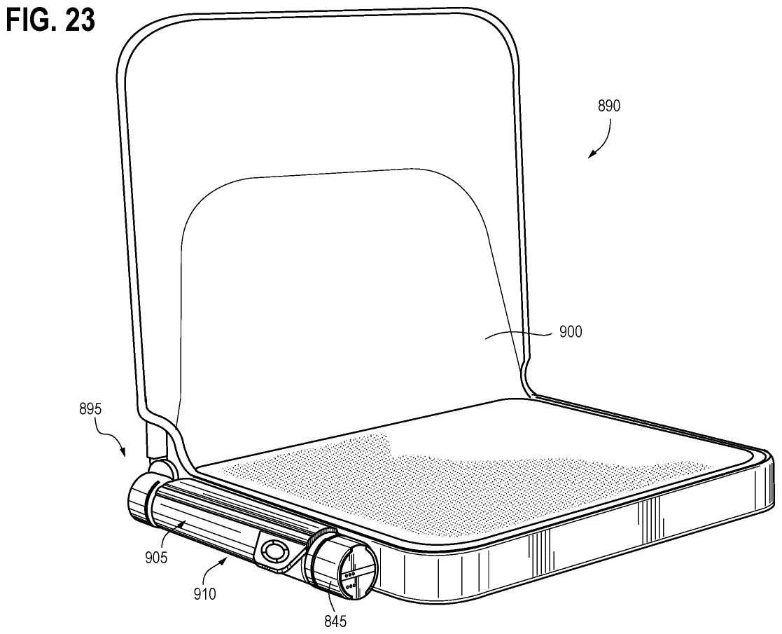

One such example technological device, a heated seat pad 875, is illustrated in FIG. 22. The seat pad 875 is generally constructed as a rectangular pad, though other shapes are foreseeable. A side portion 880 of the pad 875 preferably includes a wrap member 885 attached thereto in which the receptacle 845 (with batteries) may be placed. The wrap member 885 may be constructed in a number of ways but is preferably a fabric structure that can roll into itself to form an elongated loop, as illustrated. The loop may be connected to itself via a hook and loop fastener, zipper, or the like. The wrap member 885 is preferably provided such that the batteries in the receptacle 845 may be in communication (for example by electronic cords) with a heat source (not illustrated) in the seat pad 875. As a result, a user may turn the heat source on or off when pressing the button 870 or otherwise activating the batteries to heat up the seat pad 875 when heat is desired or turn it off when heat is not desired. The button 870 may include finer controls to adjust the heat generated in some embodiments.

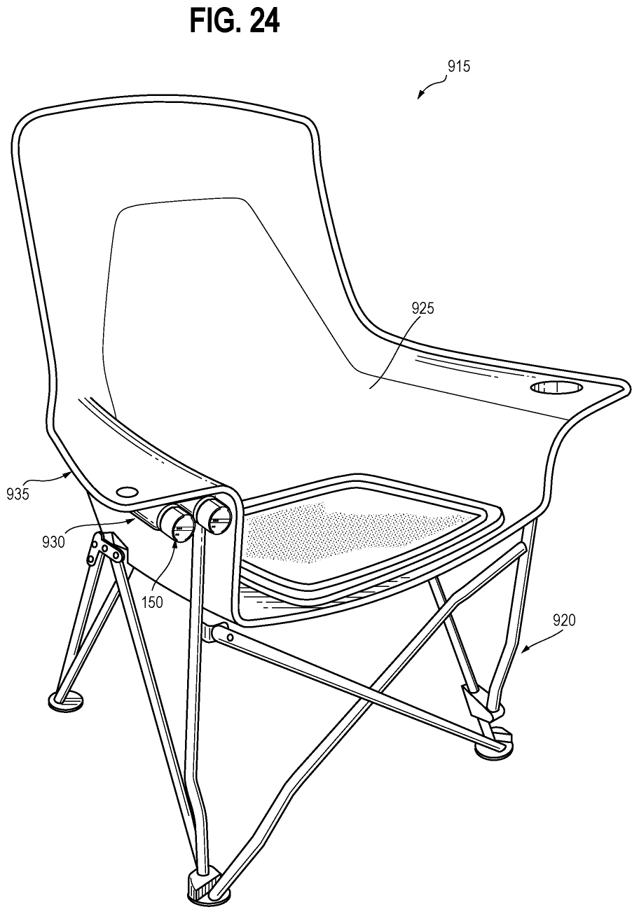

Another device, a heated stadium seat 890 that may be powered by batteries such as the batteries 5 within the receptacle 845, is illustrated in FIG. 23. The seat 890 generally includes a frame member 895 that supports a heatable fabric 900. The fabric 900 preferably includes or is otherwise in communication with a heat source powered by batteries in the receptacle 845 so that a user may operate the button 870 or otherwise activate the batteries 5 to provide power to the seat 890 via the fabric 900. Like the seat pad 875, the stadium seat 890 includes a wrap member 905 attached to a side portion 910 of the stadium seat 890 in which the receptacle 845 (with batteries) may be placed. The wrap member 905, like the wrap member 885, may roll into itself to form an elongated loop, as illustrated and may be connected to itself via a hook and loop fastener, zipper, or the like. Other constructions for the wrap member 905 such as being constructed as one or more straps are also envisioned.

A heatable, collapsible chair 915 is illustrated that may also be powered by the batteries 5. Unlike the pad 875 and the seat 890, however, the batteries 5 that power the heat source responsible for heating the chair 915 are contained in the charging station 105, which may, as set forth above, act as a rechargeable battery or as an external battery pack. The battery pack 105 may store two batteries 5 like the receptacle 845, but is less elongated and thus may be a more appropriate size for certain applications. The battery pack 105 and the receptacle 845, however, are interchangeable. Collapsible chair 915 generally includes a frame member 920 that is collapsible in a manner known in the art for easy stowing but expandable to serve as a chair frame. The frame member 920 may act to support and secure a heatable fabric 925. The fabric 925 preferably includes or is otherwise in communication with a heat source powered by the batteries 5 in the battery pack 105 so that a user may operate battery pack 105 in a known manner to provide power to the chair 915 via the fabric 925.

To secure the battery pack 150 to the chair 915, the chair 915 preferably includes a pocket member 930 extending downward from the fabric 925 near an armrest 935 of the chair 915. Other foreseeable locations for the pocket member 930 are foreseeable, as are other constructions to secure the battery pack 105 in place when the chair 915 is in use.

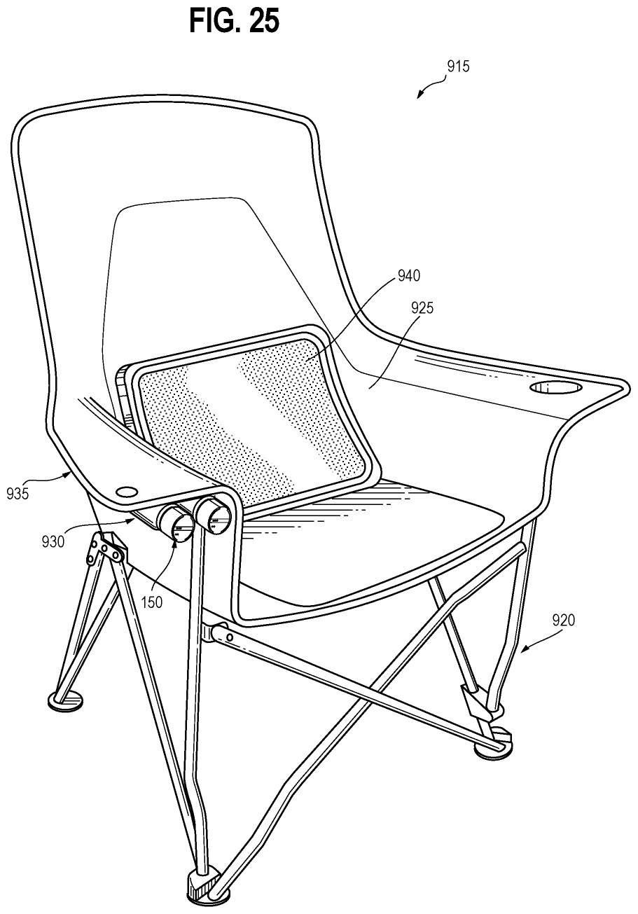

FIG. 25 provides an alternative embodiment of the chair 915. Unlike the chair 915, the chair 915 includes a heating pad 940 that may switch from being located on the seat of the chair 915 (as illustrated in FIG. 24) to its back, as illustrated in FIG. 25. The heating pad 940 is powered by the batteries 5 contained in the battery pack 105. The chair 915 also includes a collapsible frame member 920 supporting a heatable (or unheatable) fabric 925.

A heating element (not illustrated) in the heating pad 940 may be made up of copper wire, carbon fiber wire, or some other source that would convert electricity into heat. The heating pad 940 is illustrated in FIG. 25 such that it is positioned against the backrest of the chair 915.

The heating element within the pad 940 may be powered by a power source such as a battery 5 contained in the battery pack 105. The heating element may also include a controller, such as a button, to control the level of heat provided within the pad 940. The heating element/heating pad 940 may be totally removable from the chair 915, allowing the heating pad 940 to be removed for storage or when not in use to reduce the wear on the heating elements.

In any configuration, however, when attached to the chair 915 (or other furniture such as the seat 890 described above), the heating pad 940 attaches in such a way as to be movable from the seat portion of the furniture to its backrest. This may occur through rotation, removal and reattachment, or by some other means. The heating pad 940 may be held to the chair 915 or backrest by some releasably attachable structures, including but not limited to, zippers, hook and loop fasteners, and/or plastic toggles.

Advantageously, a user can adjust both the temperature and the location of the heating pad 940 to personalize his or her experience. Moreover, the use of this item may extend the camping/outdoor season.

It should be noted that the above-described systems could also be integrated into items other than outdoor furniture, including (but not limited to), sleeping bags, blankets, cots, camp pads, etc. The movable heating pad 940 could also be used not just to move between a seat and backrest, but it could also be used between other surfaces as well. For example, it could be used on a bench-style seat where a user could choose to heat a seat and a backrest, or two seats.

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. All such changes, modifications, variations and other uses in applications which do not depart from the spirit and scope of the present inventions are deemed to be covered by the inventions which are limited only by the claims which follow.

1. A system for powering various technological devices, the system comprising:
a rechargeable battery;
a receptacle containing the rechargeable battery;
a furniture member including a fabric cover, the fabric cover in electronic communication with a heat source; and
wherein the receptacle containing the rechargeable battery is in electrical communication with the heat source to provide power to the heat source to the furniture member.

2. The system of claim 1, wherein the system includes a wrap member positioned and located on the furniture member to which the receptacle is securable.

3. The system of claim 1, wherein the system includes a pocket member positioned and located on the furniture member in which the receptacle is securable.

4. The system of claim 1, wherein the furniture member is a heatable seat pad.

5. The system of claim 1, wherein the furniture member is a heatable stadium seat.

6. The system of claim 1, wherein the furniture member is a collapsible chair.

7. The system of claim 1, wherein the receptacle is configured to contain two or more rechargeable batteries that are placed side-by-side relative to one another.

8. The system of claim 1, wherein the receptacle is configured to contain two or more rechargeable batteries that are placed side-by-side relative to one another.

9. The system of claim 1, wherein the receptacle is configured to contain two or more batteries that are placed so that end portions of the two or more batteries abut one another.

10. A structure comprising:
a seat;
a fabric covering the seat;
a heat source in communication with the seat;
two or more rechargeable batteries for providing power to the heat source;
a receptacle for receiving the two or more rechargeable batteries therein, receptacle being in electrical communication with the heat source.

11. The structure of claim 10 wherein the receptacle is configured to contain two or more rechargeable batteries that are placed side-by-side relative to one another.

12. The structure of claim 10 wherein the receptacle is configured to contain two or more rechargeable batteries that are placed side-by-side relative to one another.

13. The structure of claim 10, wherein the seat is supported by a frame member.

14. The structure of claim 13, wherein the frame member is collapsible.

15. The structure of claim 10, wherein the structure includes a wrap member positioned and located on the seat to which the receptacle is securable.

16. The system of claim 10, wherein the structure includes a pocket member positioned and located on the seat in which the receptacle is securable.

17. The system of claim 10, wherein the seat includes a heat pad in communication with the heat source, the heat pad being movable between a location between a seat portion of the seat and a back portion of the seat.
